(19) United States
(12) Patent Application Publication
(10) Pub. No.: US 2017/0004547 A1
(43) Pub. Date: Jan. 5, 2017

(54) QUEUING AND NUMBER CALLING METHOD AND SYSTEM

(71) Applicant: YA-CHUN CHIANG, Taichung City 40452 (TW)

(72) Inventors: YA-CHUN Chiang, Taichung City 40452 (TW); KUO-JUNG Li, Taichung City 40452 (TW)

(21) Appl. No.: 15/197,280

(22) Filed: Jun. 29, 2016

(30) Foreign Application Priority Data
Jun. 30, 2015 (TW) 104121041

(51) Int. Cl. G06Q 30/02; G06F 17/30; G06Q 20/10

(52) U.S. Cl. CPC G06Q 30/0281; G06Q 20/10; G06F 17/30268

(57) ABSTRACT

A queuing and number calling method includes a number taking step, an image capturing step, an accessing step and a number calling step. In the number calling step, a currently called number is displayed, and an image corresponsive to the number is transmitted to a display device for a display viewed by a service personnel to know about the number taker's related appearance or clothing. An image of the number taker is captured while the number taker is taking a number, and the number taker's image is analyzed, so that the service personnel can locate the customer directly after viewing the number taker's image or related information, so as to assist customers to reduce the chance of passing the number.

### FIELD OF THE INVENTION

The present invention relates to a queuing and number calling system and method, more particularly to the system and method provided for service personnel to actively learn a number taker's appearance and characteristics.

### BACKGROUND OF THE INVENTION

A queue is a group of people lining up one after the other. In present societies, queuing is a method for allocating limited resources to achieve the fair first-come-first-serve purpose. Therefore, many companies have been using this method and setting up a plurality of windows or counters in the unit to serve a crowd of people, and digital service personnel assist and service more customers within a specific period of time.

In the traditional methods, a customer usually chooses a queue with the smallest number of people to line up before coming up to a window or counter. Sometimes, the line with the smallest number of people may take more queuing time, particularly when someone in the line needs to handle a more complicated matter, and thus failing to achieve the fair first-come-first-serve purpose. In addition, a long queue time may cause discomfort to disabled people.

Later, a number calling machine was introduced, and the number calling machine is capable of generating a number slip, and a queuer takes a number slip to complete the queuing process, so that an earlier corner draws a smaller number and a service personnel will call the numbers sequentially. However, this method still has the following problems: The queuer may forget her/his number, remember a wrong number, or pass a number while focusing on using a mobile device, and thus the service personnel at the scene has to repeat calling the same number and wait for the customer. Since the service personnel do not know the customer of the calling number, therefore the service personnel cannot remind the customer actively. If a customer passes a number, the customer needs to take a new number slip and wait, and the service personnel repeats calling the number and delays the service, so that the overall performance will drop.

### SUMMARY OF THE INVENTION

In view of the problems of the prior art, the inventor of the present invention based on years of experience in the related industry to improve the conventional methods by taking a number taker's image and analyzing the number taker's image, so that the service personnel is cable to recognize the number taker and locate the customer directly and actively remind the customer actively.

To achieve the aforementioned and other objectives, the present invention provides a queuing and number calling method, and queuers take numbers respectively one by one, and the method comprises a number taking step, an image capturing step, an accessing step, and a number calling step.

In the number taking step, a number taker takes a number from a number taking machine. In the image capturing step, an image capturing device is turned on to capture a number taker's image while the number taker is taking the number. In the storing step, the captured image and the corresponsive number are stored in a database. In the number calling step, the currently called number is displayed, and the image corresponsive to the number is transmitted to a display device and displayed for the viewing of the service personnel.

In the aforementioned method, when the service personnel is calling a number, the displayed screen shows the customer's appearance or related identification information. If necessary, the corresponsive queuer will be reminded actively to achieve the effects of reducing the chance of missing a number and improving the service quality.

Preferably, a user may perform the operations of shopping and making a payment at the number taking machine.

The present invention further provides another queuing and number calling method, and queuers take numbers respectively one by one, and the method comprises a number taking step, an image capturing step, a storing step, an image analyzing step, and a number calling step.

The present invention is characterized in that an image capturing device is turned on to capture a number taker's upper body image or whole body image during the image capturing step; a clothing image of the upper body image or whole body image is analyzed and the result is stored into the database during the image analyzing step; and the analyzed clothing color of the upper body image, the whole body image, or the image corresponsive to the number is transmitted to a display device of the service personnel directly for display during the number calling step.

Since the displayed image includes the number taker's clothes and model which facilitate the service personnel to recognize the number taker, or allow the service personnel to recognize and locate the corresponsive number taker through the color analysis, and show the color or model of the number taker's clothing, and thus the invention has the advantage of locating the customer actively.

In addition, the number taker may perform the operations of shopping and making payments at the number taking machine to improve the convenience of use and facilitate materials management and customer analysis.

The present invention further provides a queuing and number calling system comprising a server, a number taking machine, an image capturing equipment, a number calling device and a display device.

The server is coupled to the number taking machine, the image capturing equipment, the number calling device, and the display device via signals. The number taking machine is primarily provided for the number taker to take a number. The image capturing equipment is coupled to the server and the number taking machine via signals, such that when the number taking machine issues a number, the image capturing equipment captures an image of the number taker and transmits the captured image to the server and stores the corresponsive number. The number calling device is provided for a number caller to turn to the next number and display the number. The display device is coupled to the server via signals, such that when the number calling device turns to the next number, the server will display the image or information corresponsive to the number on the display device. Therefore, this system not just provides the information of the number to the service personnel to find the number taker only, but also provides the information to actively locate the number taker in order to reduce the chance of passing a number.

Preferably, the server further comprise an image analyzing unit for analyzing the number taker's clothes or appearance characteristic or clothing color in the captured image and facilitating the service personnel to learn the characteristics of the number taker through text and to locate the number taker.

Preferably, the number taking machine is a sensing device coupled to a mobile device of the number taker via signals, and provided for transmitting a number to the mobile device, so as to reduce the waste of paper.

Preferably, the server further stores a plurality of customer photos coupled to an identification authentication, and the number taking machine is coupled to the mobile device via signals, and when a mobile authentication stored in the mobile device is received or retrieved, the customer photo and image corresponsive to the mobile authentication are displayed on the display device. Therefore, the service personnel can identify the customer at the first moment when the customer is conducting a business, so as to reduce theft and unauthorized access.

Further, the number taking machine may be integrated with a shopping unit and a payment unit, so that a user may perform the related operations of shopping and making payment to reduce labor cost.

The technical contents of this disclosure will become apparent with the detailed description of preferred embodiments accompanied with the illustration of related drawings as follows. It is intended that the embodiments and figures disclosed herein are to be considered illustrative rather than restrictive.

### BRIEF DESCRIPTION OF THE DRAWINGS

FIG. 1 is a flow chart of an embodiment of the present invention;

FIG. 2 is a flow chart of another embodiment of the present invention;

FIG. 3 is a schematic block diagram of a further embodiment of the present invention; and

FIG. 4 is a schematic block diagram of another further embodiment of the present invention.

### DESCRIPTION OF THE PREFERRED EMBODIMENTS

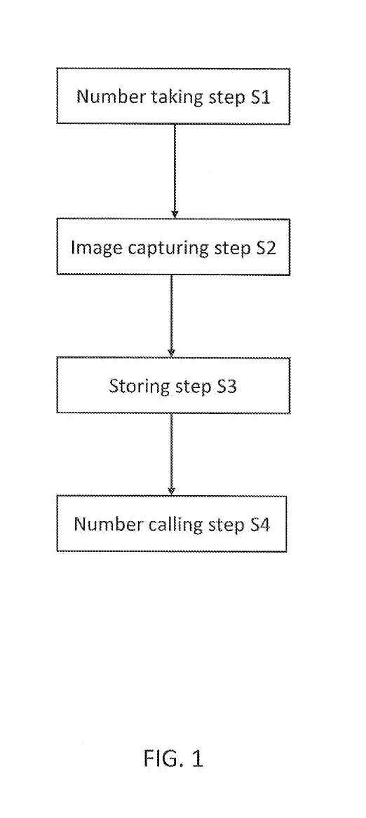

With reference to FIG. 1 for a queuing and number calling method in accordance to an embodiment of the present invention, the invention allows a service personnel to know the current appearance or characteristics of a number taker and prevent number taker to miss his/her number when the number is called and reduces the waste of time on repeating the calling of the same number.

In this method, when a queuer takes a number in turn, the queuer's image is captured and displayed on a display device and viewed by a number caller (or the service personnel), so that the service personnel knows the appearance or clothing of the number taker's appearance or clothing directly.

The queuing and number calling method in accordance with an embodiment of the present invention comprises a number taking step S1 an image capturing step S2, a storing step S3, and a number calling step S4.

In the number taking step S1, a number taker takes a number from a number taking machine, so that the number taker knows his/her own number. Wherein, the number may be printed on a piece of paper, an electronic slip or transmitted to a mobile device. Further, the number taker may do shopping and make payment at the number taking machine.

In the image capturing step S2, an image capturing device is turned on to capture a number taker's image while the number taker is taking a number, wherein the image may be the number taker's face, head, upper body, or whole body.

In the storing step S3, the captured image and the corresponsive number are stored in a database.

In the number calling step S4, the currently called number is displayed, and the image corresponsive to the number is transmitted to a display device for a display viewed by the number caller.

This method lets the number caller view the number taker's image directly and uses the image as a basis to locate the number taker and confirm whether or not the number taker is at the scene in order to reduce the times of calling the same number. Particularly, people usually lower their head and use the mobile device while waiting, and ignore the sequence of the calling numbers. This method provides a method for the number caller to find and notice the number taker, so as to reduce the chance of passing a number.

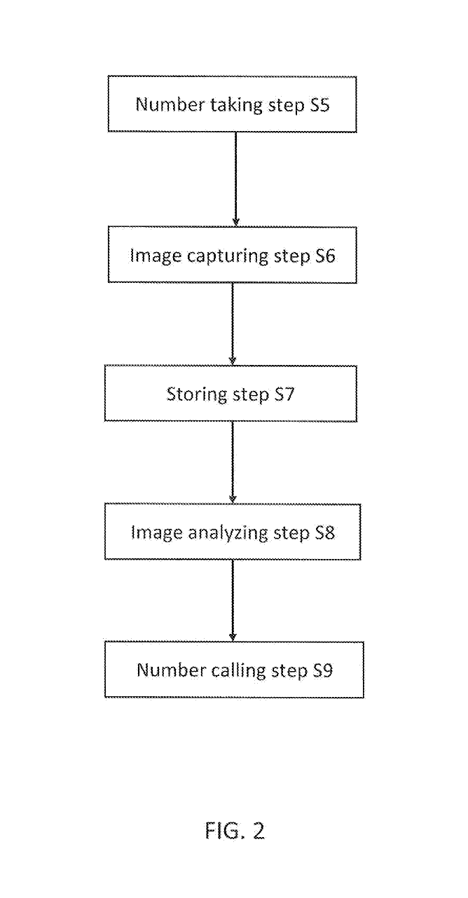

With reference to FIG. 2 for a queuing and number calling method in accordance with another embodiment of the present invention, the method comprises the following steps:

In the number taking step S5: a number taker takes a number from a number taking machine, wherein the number may be printed on a piece of paper, in form of an electronic slip, or transmitted to a mobile device. Further, the number taker may further perform the operations of shopping or making payment at the number taking machine.

In the image capturing step S6, an image capturing device is turned on to capture the number taker's upper body image or whole body image while the number taker is taking a number.

In the storing step S7, the captured upper body image or whole body image and the corresponsive number are stored into a database.

In the image analyzing step S8, the clothing image of the captured upper body image or whole body image is analyzed, and the result is stored into the database, so that each number has its corresponsive clothing color information.

In the number calling step S9, the currently called number is displayed, and the analyzed clothing color of the upper body image or the whole body image or the image corresponsive to the number is transmitted to a display device for a display viewed by the service personnel.

The service personnel (or the number caller) knows a number taker's clothing color from the display device, and the clothing color is recognized to locate and remind the corresponsive number taker, so that the number taker will not miss the number or need to take a new number.

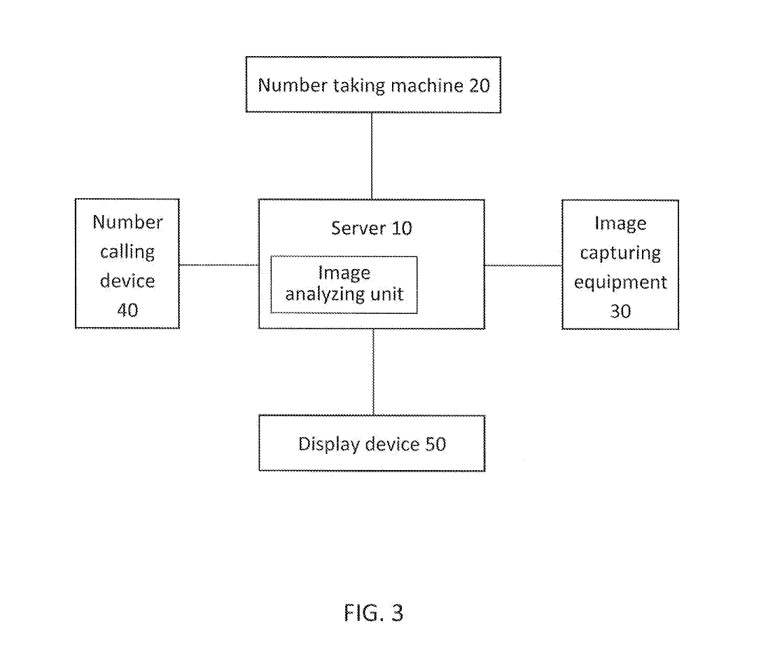

With reference to FIG. 3 for a queuing and number calling system in accordance with another embodiment of the present invention, the queuing and number calling system comprises a server 10, a number taking machine 20, an image capturing equipment 30, a number calling device 40, and a display device 50.

The server 10 is coupled to the number taking machine 20, the image capturing equipment 30, the number calling device 40, and the display device 50 via signals. The server 10 integrates the signals of the number taking machine 20, the image capturing equipment 30, and the number calling device 40 and instructs and controls the operation of these devices.

The number taking machine 20 is primarily provided for the number taker to take a number which serves as a basis of the queue, and a queuer may process his/her business according to the sequence of the numbers, wherein the number taking machine 20 may be a sensing device coupled to the number taker's mobile device via signals, and provided for transmitting a number to the mobile device, or showing the number in form of a piece of paper or electronic paper.

The image capturing equipment 30 is coupled to the server 10 and the number taking machine 20 via signals, such that when the number taking machine 20 issues a number, the image capturing equipment 30 captures the number taker's image and transmits the captured image to the server 10 and stores the corresponsive number. Wherein, the captured position of the image is not limited, and it can be the number taker's head, face, upper body, or whole body.

The number calling device 40 is provided for a number caller (or the service personnel) to turn to the next number and show the number, so that the number taker knows the current number, and the number taker having the current number may go to the counter to process the related business.

The display device 50 is coupled to the server 10 via signals, such that when the number calling device 40 turns to the next number, the server 10 will display the image or information corresponsive to the number on the display device 50. The display device 50 is provided for number caller to view the number taker's image or information in order o determine whether or not the number taker remains at site.

The display device 50 displays the number taker's image or information which are provided for the number caller to recognize and locate the number taker, so as to reduce the chance for the number taker to miss her/his number.

The server 10 further comprises an image analyzing unit for analyzing the number taker's clothes or appearance characteristic or clothing color in the captured image. Such information is provided to the service personnel to improve the number caller's convenience of finding the number taker and also improve the efficiency.

The server 10 may store a plurality of customer photos coupled to an identification authentication, and after the number taking machine 20 is coupled to a mobile device of the number taker via signals, the mobile device receives or retrieves the stored mobile authentication. When a number is called, the mobile authentication displays the corresponsive customer photo stored in the server 10 and the instantly taken image on the display device 50. Therefore, the number caller can do the security check at the same time. If the number taker does not look like the customer photo stored in the server 10, related security mechanisms may take place to prevent theft or unauthorized access actively.

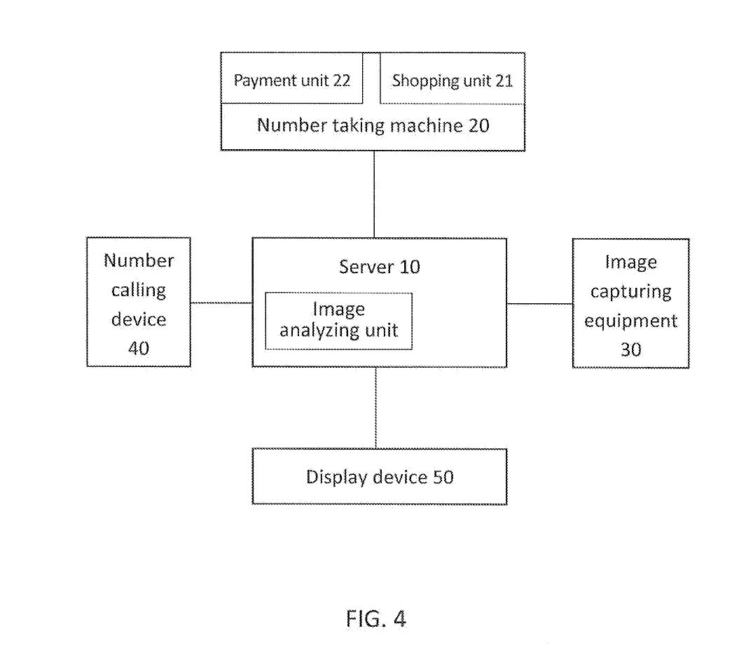

In FIG. 4, the number taking machine 20 is further combined with a shopping unit 21 and a payment unit 22, so that a user may do shopping at the number taking machine 20, and a mobile payment system may be integrated and provided for the user to consume. In the meantime, the related information of the captured image such as sex, age, etc is analyzed, so that the group of customers and the consuming behavior of each group of customers may be analyzed to facilitate purchase or materials management. If the present invention is applied to restaurant, the materials preparation and analysis will be easier, and the quantity of food materialss can be prepared more precisely to avoid unnecessary waste of food materialss. Wherein, the shopping unit 21 may be a POS main system, a computer, a mobile device, etc, and the payment unit 22 may be an inductive card reader, an IC card reader, or a mobile payment unit combined with a mobile device, or an online payment via a mobile device.

Therefore, the manual cashier operation may be avoided to reduce labor cost, or wrong orders caused by manual ordering, or miscalculation of dollar amount.

While the invention has been described by means of specific embodiments, numerous modifications and variations could be made thereto by those skilled in the art without departing from the scope and spirit of the invention set forth in the claims.

What is claimed is:

1. A queuing and number calling method, and queuers taking numbers respectively one by one, and the method comprising the following steps:
a number taking step, provided for a number taker to take a number taker from a number taking machine;
an image capturing step, for turning on an image capturing device to capture the number taker's image while the number taker is taking a number;
a storing step, for storing the captured image and the corresponsive number into a database; and
a number calling step, for displaying the currently called number, and transmitting the image corresponsive to the number to a display device for a display viewed by a service personnel

2. The queuing and number calling method according to claim 1, wherein the number taker further shops and makes a payment at the number taking machine during the number taking step.

3. A queuing and number calling method, and queuers taking numbers respectively one by one, and the method comprising the following steps:
a number taking step, provided for a number taker to take a number from a number taking machine;
an image capturing step, for turning on an image capturing device to capture the number taker's upper body image or whole body image while the number taker is taking a number;
a storing step, for storing the captured upper body image or whole body image and the corresponsive number into a database;
an image analyzing step, for performing a clothing image analysis of the captured upper body image or whole body image, and storing the result into the database;
a number calling step, for displaying the currently called number, and transmitting the analyzed clothing color of the upper body image, or the whole body image, or the image corresponsive to the number to a display device for a display viewed by the service personnel.

4. The queuing and number calling method according to claim 3, wherein the number taker further shops and makes a payment at the number taking machine during the number taking step.

5. A queuing and number calling system, comprising:
a server;
a number taking machine, coupled to the server via signals, and provided for a number taker to take a number;
an image capturing equipment, coupled to the server and the number taking machine via signals, such that when the number taking machine issues a number, the image capturing equipment captures the number taker's image and transmits the captured image to the server to store the corresponsive number;
a number calling device, coupled to the server via signals, and provided for the number caller to turn to the next number and display the number; and
a display device, coupled to the server via signals, and provided for the number caller to view the image corresponsive to the called number.

6. The queuing and number calling system according to claim 5, wherein the server further comprises an image analyzing unit for analyzing the number taker's clothes or appearance characteristic or clothing color of the captured image.

7. The queuing and number calling system according to claim 5, wherein the number taking machine is a sensing device coupled to a mobile device of the number taker via signals and provided for transmitting a number to the mobile device.

8. The queuing and number calling system according to claim 7, wherein the server further stores a plurality of customer photos coupled to an identification authentication, and after the number taking machine is coupled to the mobile device via signals, a mobile authentication stored in the mobile device is received or retrieved, and when a number is called, the customer photo and the image corresponsive to the mobile authentication are displayed on the display device.

9. The queuing and number calling system according to claim 5, wherein the number taking machine further comprises a shopping unit and a payment unit.
